(19) United States
(12) Patent Application Publication
(10) Pub. No.: US 2015/0324830 A1
(43) Pub. Date: Nov. 12, 2015

(54) REWARDS CARD RECOMMENDATION TOOL

(71) Applicant: BANK OF AMERICA CORPORATION, Charlotte, NC (US)

(72) Inventors: Vignesh Chandrasekaran, Chennai (IN); Lekha Ananthakrishnan, Hyderabad (IN); Nirmalya Banerjee, Hyderabad (IN)

(73) Assignee: BANK OF AMERICA CORPORATION, Charlotte, NC (US)

(21) Appl. No.: 14/274,124

(22) Filed: May 9, 2014

(51) Int. Cl. G06Q 30/02

(52) U.S. Cl. CPC G06Q 30/0226

(57) ABSTRACT

Embodiments of the present invention provide apparatuses and methods that present reward accounts to users in order to help the users determine which reward accounts meet the spending habits of the users. In some embodiments the reward accounts may be credit cards, debits cards, other types of account cards, offer cards that can be used along with various payments methods, savings accounts, checking accounts, lines of credit, or any other like account that may be used for user expenses. Embodiments of the invention provide a reward account recommendation tool that may be utilized in a number of different ways to help users of reward accounts determine which reward accounts the users should utilize based on the user's expenses for various categories.

### FIELD

This invention relates generally to the field of systems and methods for matching users with recommended products, and more particularly embodiments of the invention relate to systems and methods for presenting recommended reward cards to users to maximize the benefits that users may receive from using the reward cards.

### BACKGROUND

Identifying what reward cards to use for what transactions may be difficult for users to determine. Providing various ways of recommending reward cards to users may help users determine what cards to use for what transactions.

### BRIEF SUMMARY

Embodiments of the present invention address the above needs and/or achieve other advantages by providing apparatuses (e.g., a system, computer program product, and/or other device) and methods that help present reward accounts to users (e.g., customers, clients, potential customers, potential clients, or the like) in order to help the users determine which reward accounts meet the spending habits of the users. In some embodiments the reward accounts may be credit cards, debits cards, other types of account cards, offer cards that can be used along with various payments methods, savings accounts, checking accounts, lines of credit, or any other like account that may be used for user expenses. Embodiments of the invention provide a reward account recommendation tool that may be utilized in a number of different ways to help users of reward accounts determine which reward accounts best suit the user's expenses (e.g., transactions, payments, or the like).

Embodiment of the present invention comprise systems, computer program products, and methods for providing account recommendations based on rewards associated with accounts and expenses of a user. The present invention identifies user expenses for one or more categories from one or more current accounts of the user; identifies current rewards associated with the one or more current accounts for the one or more categories; identifies available rewards associated with one or more available accounts for the one or more categories; determines one or more recommended accounts for the one or more categories to maximize the rewards for the user based on the current rewards associated with the one or more current accounts, the available rewards associated with the one or more available accounts, and the user expenses for the one or more categories; and displays the one or more recommended accounts to the user.

In further accord with an embodiment of the invention, the user expenses for the one or more categories are manually inputted by the user through an expense interface.

In another embodiment of the invention, the user expenses for the one or more categories are automatically provided by a financial institution that provides the one or more current accounts to the user and stores expense information related to the user expenses.

In still another embodiment of the invention, the user expenses for the one or more categories are automatically provided by a third-party institution that stores expense information related to the user expenses for the one or more current accounts.

In yet another embodiment, the present invention comprises identifying the one or more available accounts for which the user is eligible; and wherein determining the one or more recommended accounts is further based on the one or more available accounts for which the user is eligible

In further accord with an embodiment of the invention, the present invention comprises receiving an indication from the user for the rewards in which the user is interested; and wherein determining the one or more recommended accounts is further based on the rewards in which the user is interested

In another embodiment of the invention, displaying the one or more recommended accounts to the user comprises displaying the one or more recommended accounts in an online banking application of the user.

In still another embodiment of the invention, displaying the one or more recommended accounts to the user comprises displaying estimated rewards for the one or more recommended accounts based on the user expenses compared to the current rewards for the one or more current accounts based on the user expenses.

In yet another embodiment of the invention, displaying the one or more recommended accounts to the user comprises displaying estimated rewards for the one more categories for the one or more recommended accounts based on the user expenses compared to the current rewards for the one or more categories for the one or more current accounts based on the user expenses.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level process flow for recommending reward accounts, in accordance with one embodiment of the present invention;

FIG. 2 illustrates a process flow for recommending reward accounts based on user inputted expense variables, in accordance with one embodiment of the present invention;

FIG. 3 illustrates a process flow for recommending reward accounts based on automatically imputed expense variables, in accordance with one embodiment of the present invention;

FIG. 4 illustrates an expense interface for inputting expense variables, in accordance with one embodiment of the present invention;

FIG. 5 illustrates an authentication expense interface for automatically receiving expense variables, in accordance with one embodiment of the present invention;

FIG. 6 illustrates an account interface with a reward account notification, in accordance with one embodiment of the present invention;

FIG. 7 illustrates an expense variable interface from which data may be used to determine expense variables, in accordance with one embodiment of the present invention; and

FIG. 8 illustrates a block system diagram for a reward account recommendation system environment, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses or institutions that take the place of or work in conjunction with the financial institution or bank to perform one or more of the processes or steps described herein as being performed by a financial institution or bank. Still in other embodiments of the invention the financial institution or bank described herein may be replaced with other types of businesses or institutions that offer account services to users.

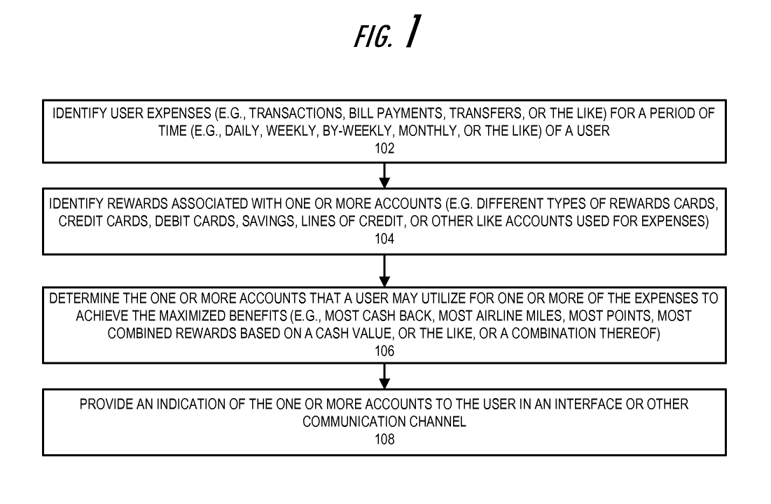

FIG. 1 illustrates a high-level process flow for recommending reward accounts, in accordance with one embodiment of the present invention. The invention may be discussed herein with respect to a financial institution recommending reward cards, but it should be understood that the present invention may be utilized by any institution in order to recommend any type of account for maximizing the rewards that may be earned by the user 9 based on the expenses of the user 9.

As illustrated in block 102 of FIG. 1, an institution (e.g., financial institution, financial software provider, merchant, or other like institution) identifies user expenses associated with a user 9. The user 9 may be an individual user with personal accounts, or a user within a business (e.g., employee, contractor, agent, or the like of the business) that utilizes an account for expenses related to the business. The user expenses, as will be described in further detail later, may be payments for transactions, bill payments, fund transfers, or any other type of instance when a user 9 authorizes the outflow of funds from an account or funds charged to an account owned or managed by the user 9. The accounts may be associated with various types of payment instruments, such as but not limited to be credit cards, debit cards, rewards cards associated with a payment instrument, lines of credit, digital wallets, virtual payment identifiers associated with accounts, tokens associated with accounts, fobs associated with accounts, or any other type of payment instrument associated with an account for which expenses are created. As will be described in further detail later the user expenses may be identified through manual input from the user 9, by the institution identifying account information of the user 9, by the user 9 allowing the institution to import account information from third-parties, or the like.

As illustrated by block 104 of FIG. 1, the institution identifies rewards associated with various accounts of the user 9. As will be discussed in further detail later, the institution may identify the rewards for accounts that the financial institution offers, or in some embodiments rewards for other accounts that other third-parties offer. As such, the reward accounts may be accounts that a single institution provides (e.g., the accounts that a financial institution may offer customers), or may be accounts from multiple institutions (e.g., a third-party institution provides reward information for accounts across multiple financial institutions). The various accounts of the user 9 may be accounts that the user already has, accounts for which the user 9 is eligible, or accounts for which the user 9 is not currently eligible but may be eligible for in the future.

Block 106 of FIG. 1 illustrates that the institution determines one or more accounts that the user 9 may utilize for one or more of the expenses, which would maximize or provided the desired rewards to the user 9. The determination of the recommended accounts (e.g., current accounts or recommended available accounts) may be made, as least in part, based on the types of categories, the amount of the user expenses for each of the categories, and the rewards that each account provides for the categories based on the amount of the expenses (including any limits or caps on the amount of the rewards), as will be explained in further detail later.

As illustrated by block 108 in FIG. 1, after the one or more accounts are determined the present invention provides information about the accounts and the associated rewards for each of the accounts to the user 9. The one or more accounts may be displayed in an interface, or sent via another communication channel.

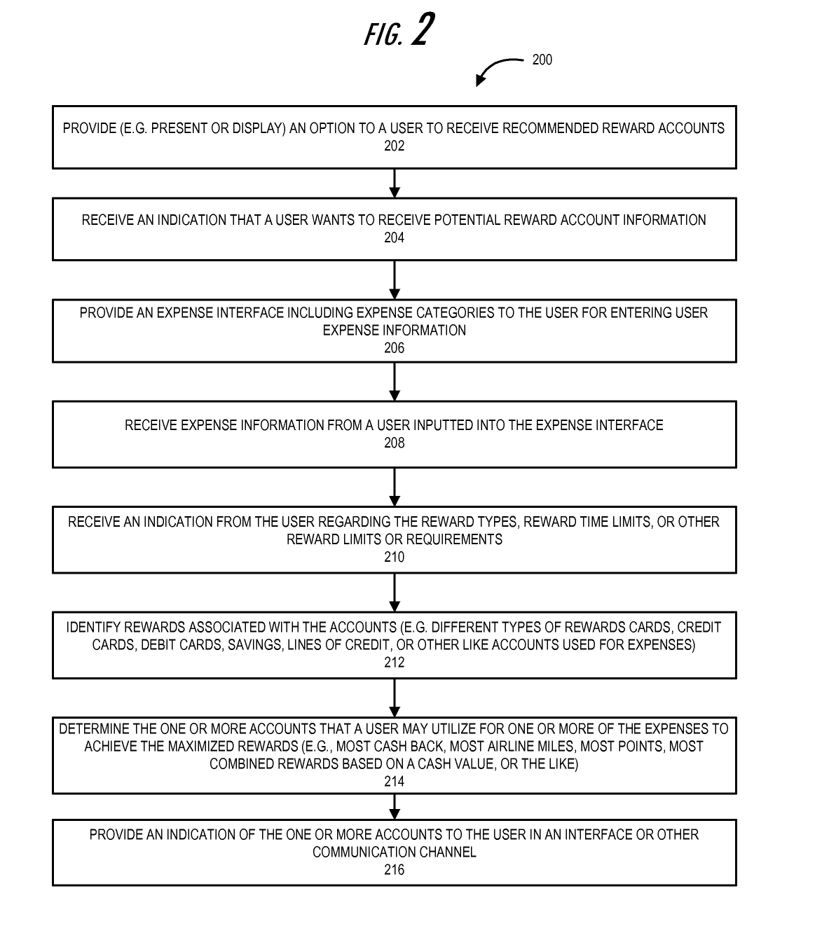

FIG. 2 illustrates a process flow for recommending reward accounts based on user inputted expense variables for various categories, in accordance with one embodiment of the present invention. As illustrated by block 202, an institution may present the user 9 with an option to identify what rewards accounts would be most beneficial to the user 9 based on the user's expenses. In one embodiment, this opportunity may be presented by a financial institution when the user 9 is viewing a website of the financial institution. In other embodiments, this opportunity may be presented to a user 9 when the user 9 is viewing any websites and the opportunity appears as an advertisement on the websites from a financial institution or another institution that provides services that allows a user 9 to manage expenses, financial accounts, or the like. In still other embodiments of the invention, this opportunity may be presented to the user 9 through a notification, such as an e-mail, text message, or any other type of communication in which an institution, such as a financial institution or third-party service provider, notifies the user 9 that the user 9 may be able to improve the rewards that the user 9 receives from using an account to pay for expenses.

As illustrated by block 204 in FIG. 2, the user 9 may indicate that the user 9 would like to receive potential reward account information for various accounts based on the user's expenses. In some embodiments the user 9 may select a feature such as an advertisement, link, icon, or other like feature (e.g., in a website, application, pop-up window, e-mail, text message, or any other electronic interface) indicating that the user 9 would like to provide expense information in order to determine the accounts that provide the best rewards for the user 9.

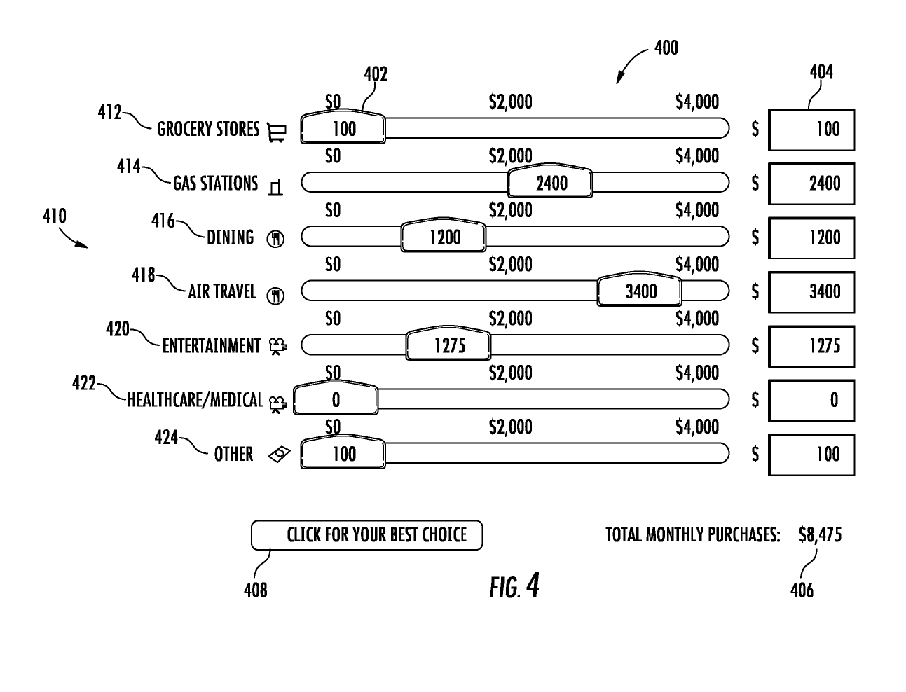

Block 206 in FIG. 2 illustrates that an expense interface 400 is provided to the user 9 by the institution. FIG. 4 illustrates one embodiment of the expense interface 400 that may be utilized by the user 9 to enter expense information for various categories 410. As illustrated in the expense interface 400, the user expenses may be broken down into expense categories 410, such as but not limited to grocery stores 412, gas stations 414, dining 416, air travel 418, entertainment 420, healthcare/medical 422, and other 424. In other embodiments of the invention the expense interface 400 may include other categories 410 in addition to the illustrated categories 410, or in lieu of the illustrated categories.

As illustrated by block 208 of FIG. 2, the institution may receive expense information from the user 9 that the user inputs into an interface, such as the expense interface 400 illustrated in FIG. 4. As illustrated in FIG. 4, the user 9 may indicate the amount that the user 9 spends for a particular period of time (e.g., a day, week, month, year, or the like) in order to provide the user's estimated expenses for the period of time. As illustrated in FIG. 4, the user 9 may utilize expense input features, such as slide features 402 or input fields 404 to input an amount that the user 9 spends for each of the categories 410 for the time period in the expense interface 400. As such, the user 9 may enter the amount of money the user 9 spends for the time period for each category by sliding the slide feature 402 to the amount spent or entering the amount spent in the input fields 404. In some embodiments the time period may also be inputted in order to allow the user 9 to enter expenses for different categories for different time periods. For example, the user 9 may have a better idea of what he/she spends on groceries on a per month basis, and on gas on a per week basis. As such, in some embodiments the reward recommendation tool will calculate the user's expenses for a specific period of time (e.g., a month) based on inputted expenses that may be based on different periods of time (e.g., weekly, monthly, yearly, or the like). The expense interface 400 in FIG. 4 may calculate and illustrate the total expenses 406 for the time period based on the input from the user 9 for each of the categories 410 as a check to confirm the user's expenses for the time period. After the user 9 inputs the expense information, the user 9 may select a submit button or other like feature to submit the expense information and receive recommended reward accounts. In some embodiments the recommended reward accounts may be displayed to the user 9 in real-time or near-real time within the expense interface 400, and as such, the user 9 may use the input features to adjust the expenses for each of the categories 410 in order to identify if changes in the expenses results in different account recommendations. In some embodiments of the invention, other interfaces may be utilized to receive expense information from the user 9 and display recommended reward accounts.

FIG. 2 illustrates in block 210 that the user 9 may also provide information to the institution related to the types of rewards in which the user 9 may be interested. For example, the user 9 may indicate that the user 9 is interested in cash back, air miles, gift cards, points towards general or specific products (e.g., goods or services), discounts for general or specific merchants, donations to charity, or any other type of reward disclosed or not specifically disclosed herein. As such, the user 9 may select one or more types of rewards in which the user 9 may be interested. The user 9 may also be able to select other features of the rewards by indicating time limits for the rewards (e.g., the user only wants rewards that don't expire, that last at least one year, or the like), or rewards that meet other requirements (e.g., no blackout dates, no limits on what and where you can spend the rewards, or the like). However, in other embodiments of the invention the user 9 does not have to select a type of reward, time limits, and/or other reward feature, and as such the reward recommendation tool provides the user 9 the maximum rewards, as explained in further detail later based solely on the expense information.

Block 212 of FIG. 2 illustrates that the institution may identify the rewards associated with various accounts for which the institution has information. In some embodiments the institution is a financial institution, and as such the financial institution may issue different types of accounts, such as credit card accounts and debit card accounts, as well as have partnerships with third-party institutions (e.g., merchants) for which the financial institution may issue accounts or agree to provide information about the third-party accounts. For example, the financial institution may issue one or more financial institution credit cards, but may also provide credit cards associated with airlines, grocery stores, gas stations, retail establishments, or other like institutions. All of the accounts (e.g., credit card, debit card, or the like) may have different types of rewards, reward limits, time limits for the rewards, or other like reward features. The institution identifies the types of rewards, time limits for the rewards, or other reward features associated with the rewards (e.g., blackout dates, spending amount limits, limits on what products can be purchased, what merchants accepts the rewards, or the like).

FIG. 2 illustrates in block 214 that the institution determines the one or more recommended reward accounts (e.g., current user accounts or new available user accounts) to present to the user 9 based at least on the expenses inputted by the user 9, as well as the reward type, reward time limits, or other reward limits, features, or requirements associated with the accounts and/or selected by the user 9 as preferable. For example, the institution may identify that the user's expenses are mostly related to air travel (e.g., an employee traveling for a business), and as such the institution identifies that an airline credit card provides the best benefits for the user 9. The determination of the best benefits for the user 9 may include determining the cash equivalent of the rewards and comparing accounts based on the cash equivalent amount. In other embodiments the best benefits may be based on the reward type, reward time limits, or other reward limits, features, or requirements.

Block 216 in FIG. 2 illustrates that the one or more recommended reward accounts may be displayed to the user 9 in an interface. The interface may be a recommendation interface, within the expense interface 400, in a pop up window, a message sent through a communication channel, or in another type of electronic display interface. The recommendation may include a single account for which the user 9 should use for all of the user's expenses; however, in other embodiments the recommendation may include multiple accounts, which the user 9 should use for different categories of transactions. For example, the recommendations may include a single credit card that would provide the most cash back to the user 9 if the user 9 used the single credit card for all of the user's expenses. In another example, the recommendations may include an indication that the user 9 should use a first account (e.g., a first credit card) for gas station purchases, a second account (e.g., a second credit card) for air travel, and a third account (e.g., a third debit card) for all other transactions. The first credit card may maximize cash equivalent rewards from gas stations, the second credit card may maximize cash equivalent rewards for airline purchases, and a third debit card may maximize cash back rewards.

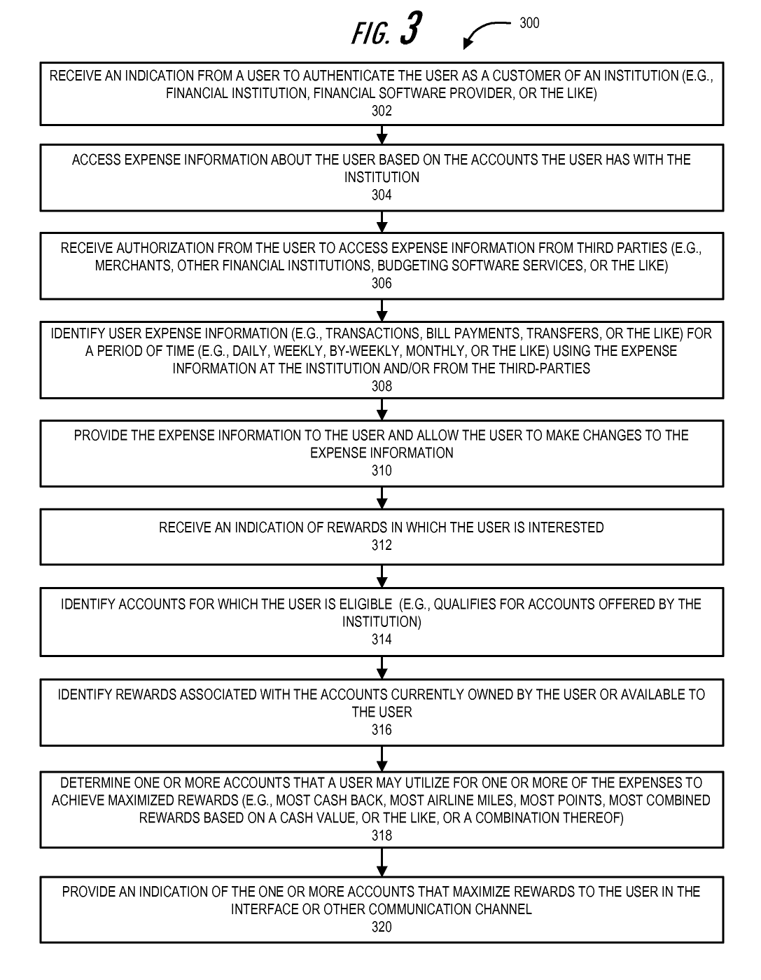

FIG. 3 illustrates a process flow for recommending reward accounts based on automatically imputed expense information, in accordance with one embodiment of the present invention. As previously discussed with respect to blocks 202 through 206 in FIG. 2 the user 9 may be presented with an option to receive recommended reward accounts; the institution may receive an indication that a user 9 wants to receive potential reward account information; and the institution may provide an expense interface including expense categories to the user 9 for entering expense information. In addition to the expense interface, or in the alternative, the institution (e.g., a financial institution or other institution that stores expense information) may provide an authentication interface 500, which allows the user 9 to sign into the user's accounts, or otherwise provide authorization to the institution to use transaction information from the user's accounts to provide the expense information.

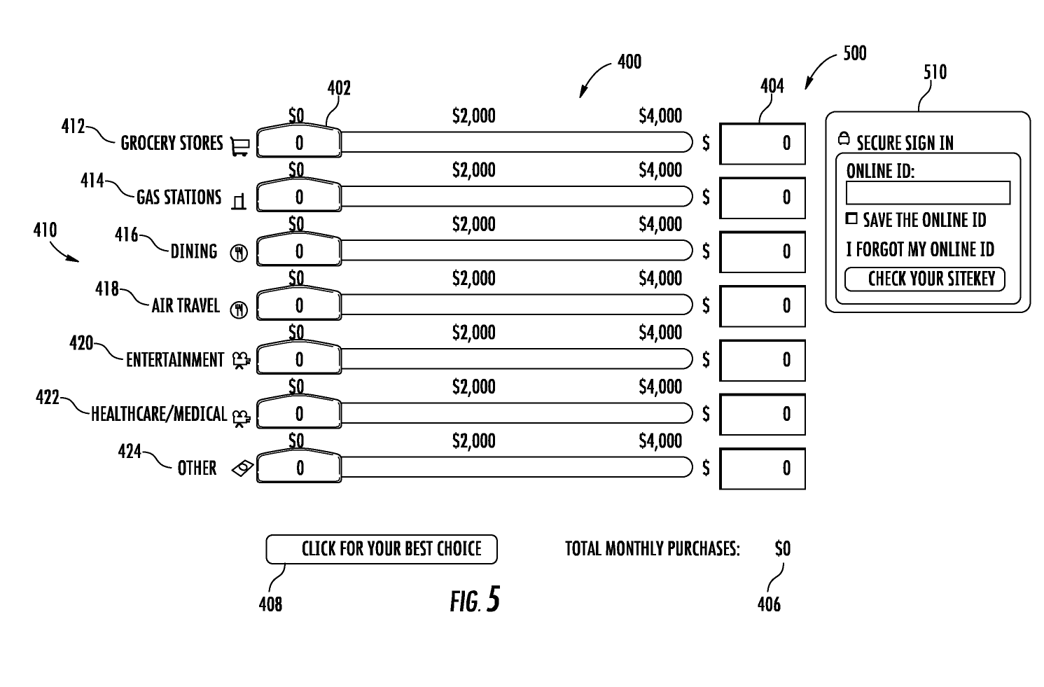

As illustrated by block 302 in FIG. 3, the institution may receive an indication from the user 9 to authenticate the user 9 as a customer of an institution. For example, as illustrated in FIG. 5 the user 9 may input the user's sign-in credentials into an authentication section 510 of the authentication interface 500. This may comprise entering a user name, site-key, password, or the like. In other embodiments any type of authentication may be utilized, such as but not limited to fingerprint scan, eye scan, palm scan, or other biometric scan, a touch screen indication password (e.g., making movements on the touchscreen in a specific pattern and sequence), an electronic device movement password (e.g., moving a smartphone in a specific pattern and sequence), facial recognition, or movement recognition (e.g., recognizing hand gestures), or any other type of authentication.

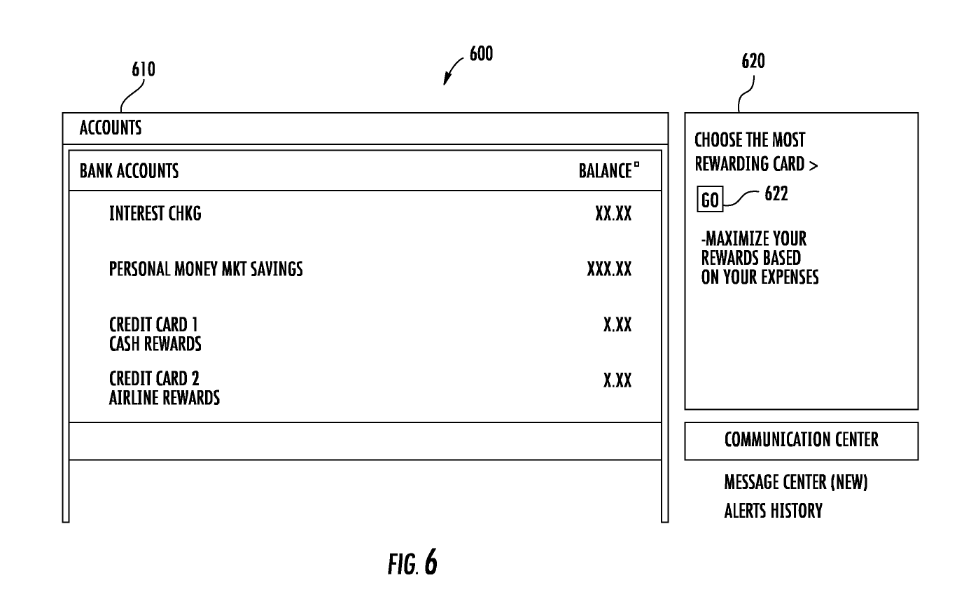

In one embodiment of the invention, instead of signing into an application to receive account information to maximize the user's rewards, the presentation of the option for the user 9 to receive recommended rewards may be provided within the user's online banking application while the user 9 is already logged into the online banking application (or within another application, such as budgeting software, or the like). For example, as illustrated in the online banking interface 600 in FIG. 6, the user 9 may be logged into the user's online banking application in order to perform actions related to the user's accounts. The financial institution (or other institution) that supports the online banking application (or other application) may have been monitoring the user's expenses (e.g., transactions) and identified that the user 9 is not maximizing the user's rewards based on the accounts the user 9 is using for expenses associated with various categories 410. As such, in some embodiments the institution may present an option to the user 9 to receive information related recommended reward accounts, when the user 9 is logged into the user's online banking application. For example, the online banking interface 600 of FIG. 6 may include and account section 610 that illustrates the user's current accounts with one or more financial institutions, and allows the user 9 to access information, such as transactions, related to these accounts. The online banking interface 600 may also include a notification section 620, which may include a button 622, link, or other like feature that the user 9 may select if the user 9 wants information related to maximizing the user's rewards based on the user's expenses. Once the user 9 selects this link the institution may being the process of gathering expense information and determining recommended accounts for the user 9 based on the expense information, as discussed in further detail below.

As illustrated by block 304 in FIG. 3, the institution may access expense information about the user 9 based on the accounts the user 9 has with the institution. For example, with respect to a financial institution the user 9 may have one or more credit card accounts, one or more debit card accounts, or one or more other accounts with the financial institution or partners of the financial institution. The financial institution may have information related to transaction data for the one or more accounts, which can be used to identify the expenses for the user 9 based on various categories, as explained in further detail below. The user 9 may subscribe to or be provided a budgeting service with the institution that utilizes the transaction data from the user accounts to provide expense information to the user 9 in an interface in real-time or near-real time. Regardless of whether or not the user 9 subscribes to or is provided a budgeting service by the institution, the institution may still be able to access transaction information from the user's accounts with the institution.

Block 306 in FIG. 3 further illustrates that the institution may receive authorization from the user 9 to access expense information from third parties (e.g., merchants other financial institutions, budgeting software services, or the like). For example, the user 9 may allow a financial institution (or budgeting service) to access the user's accounts at different merchants, different financial institutions, or budgeting software services to which the financial institution may not otherwise have access. The user 9 may provide the user's login credentials for third-party accounts to the institution on a one-time basis or a recurring basis, to allow the institution to access the third-party accounts in order to access additional expense information from the user 9 in order to identify a more accurate view of the user's expenses.

As illustrated by block 308 in FIG. 3, the institution may access expense information (e.g., transactions, bill payments, transfers, or the like) over a period of time (e.g., daily, weekly, by-weekly, monthly, or the like) using the expense information from the internal accounts within the institution or external accounts outside of the institution. If the user 9 only utilizes accounts with the internal institution, or otherwise provides access to all of the user's accounts the user 9 utilizes to make transactions, the institution may have all of the information needed to determine the user's expenses over a specified period of time. In other embodiments of the invention, the institution may not have all of the information regarding the user's accounts, but may still be able to provide the expense information collected, or may otherwise scale the expense information to estimate the user's expenses for a period of time. For example, the institution may have income information related to the income of the user (e.g., through direct deposit of income checks, income information for account or loan applications, or the like) and estimate the user's expense information based on the partial transaction information from the accounts (e.g., mortgage payments, credit card purchases, debit card purchases, automatic payment transactions, or the like) the user has with the institution and the estimated expenses for similar users (e.g., users of the same income range, age group, family size, or the like).

The institution may display the expense information to the user 9 as illustrated in block 310 of FIG. 4. Moreover, even if the institution identified the expense information automatically from the user's one or more accounts, the user 9 may have the ability to adjust the expense information for each category. As such, the user 9 may be able to change the expense information automatically determined by the institution based on transactions from accounts to which the institution does not have access, or based on cash transactions to which the institution does not have access. As previously discussed the user 9 may adjust expense input features, such as slide features 402 or input fields 404 to input amounts associated with expenses or to change automatically determined amounts for expenses for one or more of the categories 410 for one or more time periods in an interface, as illustrated in FIGS. 4 and 5.

Block 312 of FIG. 3 illustrates that in some embodiments the institution receives an indication of rewards in which the user 9 is interested. For example, the user 9 may indicate that the user 9 is interested in airline miles, cash back, entertainment gift cards, or any other type of reward, as previously discussed with respect to block 210 in FIG. 2. In some embodiments, the user 9 may rank or weight the order the rewards (e.g., reward types, or the like) in which the user 9 is interested. As such, in some embodiments of the invention the institution may be able to utilize the rewards in which the user 9 is interested in order to determine accounts to recommend to the user 9, instead of basing the recommend accounts solely on the accounts that provide maximized rewards (e.g., largest cash equivalent reward, or the like) to the user 9.

FIG. 3 illustrates in block 314 that the institution may identify accounts for which the user 9 is eligible. In some embodiments of the invention the user 9 may be presented with potential recommended accounts without knowing whether or not the user 9 would be approved for the account. However, in some embodiments the financial institution may identify if the user 9 would be approved for the account before recommending a potential account to the user 9. As such, the institution may use the access to the user's internal or external accounts in order to do a check of the user's finances to determine the additional accounts for which the user 9 would be eligible (e.g., accounts for which the institution could extend credit).

Block 316 of FIG. 3 illustrates that the institution identifies the rewards for all of the accounts, or only for the accounts for which the user 9 is eligible. In addition, the institution may also determine the rewards for the accounts that the user 9 already uses. In some embodiments, the institution may identify the rewards for both the internal accounts within the institution (e.g., the institution's accounts), and the external accounts for which the institution was given access by the user 9. For example, the institution may identify the airline miles, the cash back rewards, or any other type of rewards for the accounts that the user 9 already has, the accounts the user 9 is eligible for, as well as any accounts within or outside of the institution (e.g., if the institution is a third-party financial services provider, or the like). The institution also determines the transactions, payments, transfers, or other like actions that trigger the rewards associated with the accounts. For example, one account may provide a first percentage of a cash back reward for a first category type of transaction, a second percentage of a cash back reward for a second category type of transaction, or another percentage of a cash back reward for another category type. Moreover, the determination of the rewards may also include any limits, features, or requirements associated with the rewards, as previously discussed with respect to block 212 in FIG. 2 and block 104 in FIG. 1.

As illustrated by block 318, the institution may determine one or more accounts that the user 9 may utilize for one or more of the expenses (or categories of expenses) to achieve maximized rewards (e.g., most cash back, most airline miles, most hotel rewards, most points, most combined rewards based an equivalent cash value, or the like). The one or more accounts may include accounts that the user 9 already has, or accounts that the user 9 does not have. The determination may be made by comparing the user expenses (e.g., amount the user spends) for each of the categories, with the rewards that each account would provide for the user expenses for each of the categories. The determination may be made on an overall level (e.g., maximized rewards if the same account was used for all of the expenses) and/or on an individual or group category level (e.g., maximized rewards for using particular accounts for each of the categories or transactions within the categories). In other embodiments, the determination may also be made based on the types of rewards in which the user 9 is interested. As such, a determination may be made for the one or more accounts the user 9 should use going forward for all of the user's transactions, or for individual transactions for specific categories, in order to maximize the user's rewards or achieve the user's desired rewards.

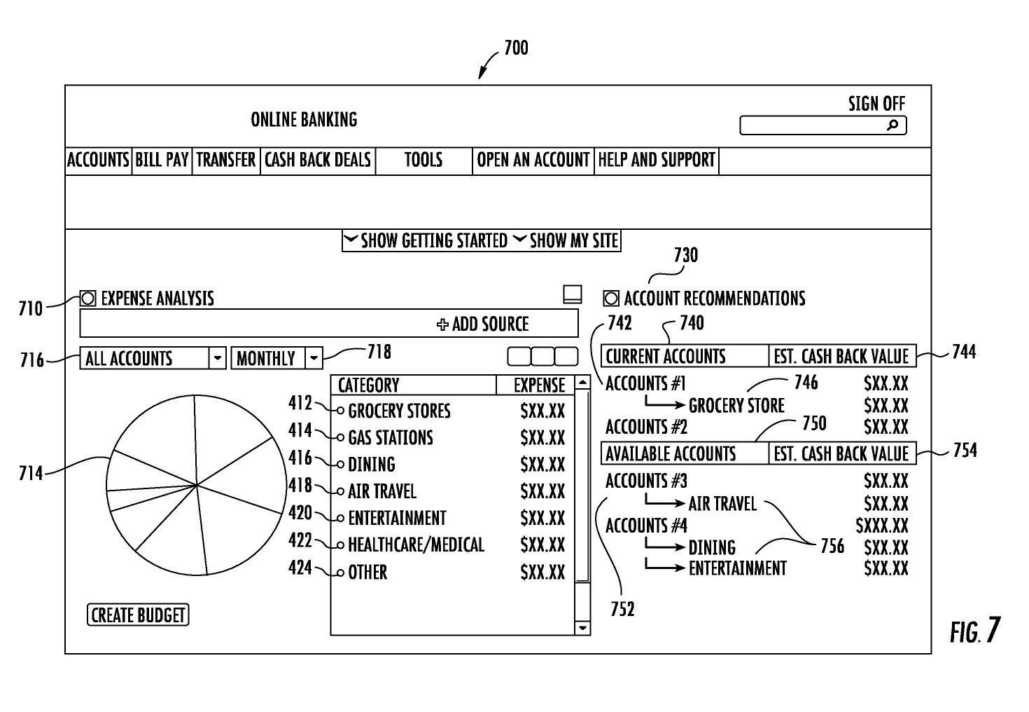

Block 320 of FIG. 3 illustrates that the institution may display an indication of the one or more accounts recommended to the user 9 (e.g., the accounts that provided the maximized rewards or the user's desired rewards). The indication may be displayed in an interface or through another communication channel. For example, the indication of the recommended accounts may be displayed in a user's online banking account, in a pop-up window, in a section of website in which the user is viewing, in an application interface in which the user 9 is utilizing, or in any other type of interface. In other embodiments of the invention the recommended accounts may be provided to the user 9 over a communication channel, such as but not limited to a text message, an instant message, an e-mail, on a screen of an ATM or other electronic terminal or kiosk, or any other type of electronic notification. In one embodiment, as illustrated in FIG. 7 the recommended accounts may be provided in an online banking account of the user 9.

As illustrated in FIG. 7, the indication may be displayed in account recommendation interface 700. The account recommendation interface 700 may be a stand-alone interface, or may be part of a budgeting interface. The account recommendation interface 700 may include a budgeting section 710 and an account recommendation section 730. The budgeting section 710 may include the same or similar information as illustrated in FIG. 4 (and FIG. 5) related to the categories 410, such as but not limited to grocery stores 412, gas stations 414, dining 416, air travel 418, entertainment 420, healthcare/medical 422, and other 424. The budgeting section 710 may further include the expense amounts 712 associated with each of the categories 410. As previously discussed the expense amounts 712 may be determined automatically based on internal accounts with an institution and/or external accounts from third parties. Moreover, as previously discussed these expense amounts 712 may be altered by the user 9. As illustrated by the budget graph section 714 the expense amounts 712 may be displayed graphically, such as through a pie chart as illustrated in FIG. 7. In some embodiments of the invention the budgeting section 710 may illustrate the expenses for all accounts, or specific accounts, over different time periods by changing the account selection feature 716 and/or the time period selection feature 718.

The account recommendation section 730 in FIG. 7 may include a recommended current account section 740 and a recommended available account section 750. The current account recommendation section 740 may include an account name 742, the rewards 744 for the account (e.g., an estimated cash equivalent value, or the like), and the recommended categories 746 with which to use the account. The current account recommendation section 740 illustrates the accounts (if any) that the user 9 current has, which the user 9 should utilize in transactions within specific categories (if any) in order to maximize the rewards for the specific categories 410. The recommended available account section 750 in the account recommendation section 730 may also include an account name 752, the rewards 754 for the account, and the recommended categories 756 with which to use the account. The recommended available account section 750 illustrates the accounts (if any) that the user 9 should apply for or open up, in order to utilize the account to enter into transactions for maximizing rewards for specific categories 410 (if any).

In other embodiments of the invention (not illustrated), the account recommendation interface 700 may illustrate a comparison of the rewards for one or more accounts the user 9 currently uses for one or more categories 410 with the rewards for one or more recommended accounts (e.g., current accounts or a new available accounts) that the user 9 should use to maximize the rewards associated with the one or more specific categories 710. As such, the user 9 may be able to see the improvement in the realized rewards by seeing the comparison between the one or more accounts the user 9 currently uses and the one or more accounts that would maximize rewards for the user's transactions.

In still other embodiments of the invention, as the uses switches between all accounts and one or more combinations of the accounts using the account selection feature 716, the account recommendation section 730 may change in real-time or near real-time to illustrate what one or more accounts the user 9 should use to maximize rewards for transactions when compared to the user accounts currently utilized by the user 9 and that the user 9 selected using the account selection feature 716.

In other embodiments the user 9 may be able to select specific categories 410 to view the rewards the user 9 currently receives using one or more current accounts for the specific category, as well as one or more recommended accounts (e.g., current accounts or available accounts) that the user 9 should use in order to maximize the user's rewards for specific categories 410.

In still other embodiments the user 9 may be able to select specific categories 410 to view the specific transactions within the categories 410 in order to determine the current accounts or the recommended available accounts that the user 9 should used for each of the specific transactions within the specific categories 410 in order to maximize the user's rewards for each of the specific transactions.

In still other embodiments of the invention, the reward account recommendation tool may also take into account expected future expenses when determining the one or more accounts to recommend to the user 9. For example, the institution (e.g., the financial institution) may identify that the user has booked a flight for a trip through account transaction information, and as such identify that the user 9 may need to book a hotel or a car. In response, the institution may recommend an account that provides maximized rewards for hotel bookings, rental car bookings, or travel rewards in general (e.g., if the user's travel expenses have been increasing, or the like). In another example, the institution (e.g., financial institution) may be able to identify that the user 9 is purchasing a house, and as such the institution may recommend an account for the user 9 that would maximize rewards for home improvement purchases.

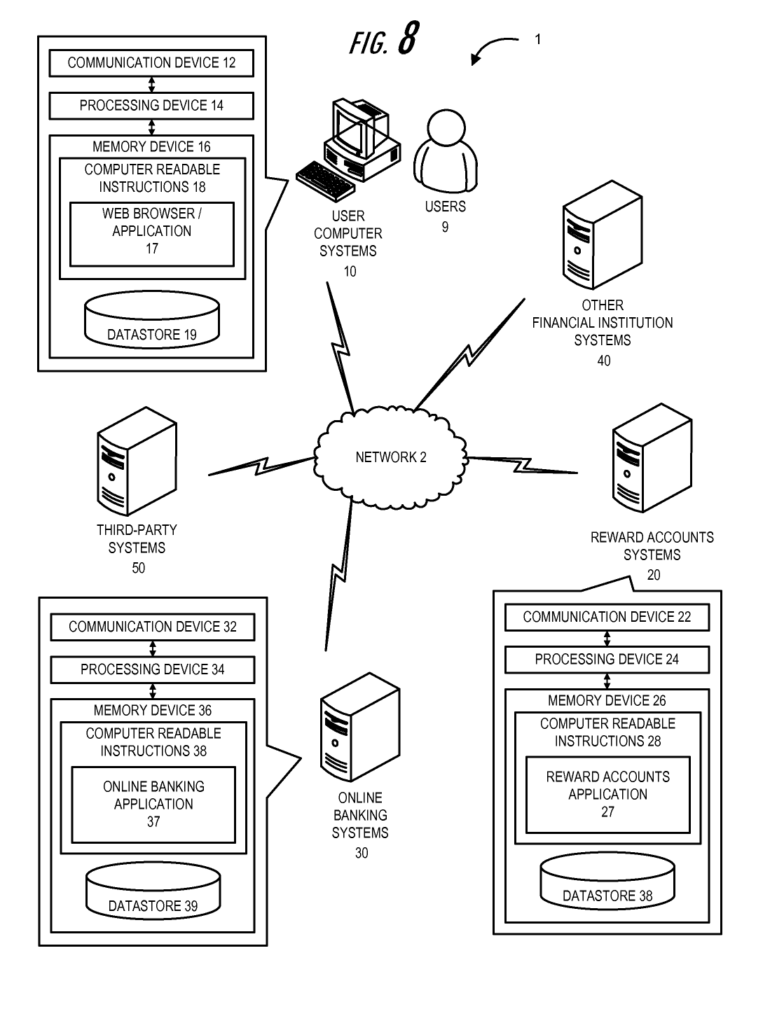

FIG. 8 illustrates a reward account recommendation system 1, in accordance with an embodiment of the present invention. As illustrated in FIG. 8, the user computer systems 10 are operatively coupled, via a network 2 to the reward accounts systems 20, online banking systems 30, other financial institution systems 40, or third-party systems 50. As discussed herein, in this way, the user computer systems 10 may be utilized by users 9 in order to receive recommended reward accounts based on expense variables inputted by the user 9 or received from a financial institution or other third-parties. As previously noted the recommended reward accounts and information for determining the recommended rewards accounts may be provided and received through the online banking accounts of the users 9 or other communication channels. FIG. 8 illustrates only one example of embodiments of a reward account recommendation system 1, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 8, the user computer systems 10 generally comprise a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the reward account systems 20, the online banking systems 30, other financial institution systems 40, or third-party systems 50. As such, the communication device 12 generally comprises a modem, server, or other device for communicating with other devices on the network 2, and a display, camera, keypad, mouse, keyboard, microphone, and/or speakers for communicating with one or more users 9. The user computer systems 10 may include, for example, a personal computer, a laptop, a mobile device (e.g., phone, smartphone, tablet, or personal display device (“PDA”), or the like) or other devices, or the like.

As further illustrated in FIG. 8, the user computer systems 10 comprise computer-readable instructions 18 stored in the memory device 16, which in one embodiment includes the computer-readable instructions 18 of a web browser or application 17. In some embodiments, the memory device 16 includes a datastore 19 for storing data related to the user computer systems 10, including but not limited to data created and/or used by the web browser or application 17. As discussed above the web browser or application 17 allows the users 9 to communicate with the reward accounts application 27 (e.g., the reward account recommendation tool, or the like), the online banking application 37, or other applications provided by the financial institution or third-party in order to provide expense information and receive reward account recommendations from a financial institution or other third-party. In some embodiments a web browser is used to access websites, applications, or the like; however, in other embodiments a specific application (e.g., mobile application, computer application, or the like) is specifically configured to communicate with the other systems and applications within the reward accounts recommendation system 1. In still other embodiments of the invention portions of other applications may be stored on the user computer systems 10, such as but not limited to the reward accounts application 27, the online banking application 37, or other applications.

As further illustrated in FIG. 8, the reward accounts systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the user computer systems 10, online banking systems 30, other financial institution systems 40, or third-party systems 50. As such, the communication device 22 generally comprises a modem, server, or other device(s) for communicating with other devices on the network 2.

As illustrated in FIG. 8, the reward account systems 20 comprise computer-readable program instructions 28 stored in the memory device 26, which in one embodiment includes the computer-readable instructions 28 of a reward accounts application 27. In some embodiments, the memory device 26 includes a datastore 29 for storing data related to the reward accounts systems 20, including but not limited to data created and/or used by the reward accounts application 27. The reward accounts application 27 (e.g., the reward account recommendation tool, or the like), as discussed above, receives information related to the expenses of a user 9 and responds with recommended reward cards. The expense information may be received from the user 9, from the financial institution, or from the third parties and displayed to users 9 through the online banking application 37 or other communication channels, other websites or applications used by the users 9, and/or on the user computer systems 10 (e.g., laptops, mobile devices such as smartphones or tablets, or the like) or on any other type of system utilized by the users 9 (e.g., ATMs, or the like).

As further illustrated in FIG. 8, the online banking systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the user computer systems 10, the reward accounts systems 20, the other financial institution systems 40, and or the third-party systems 50. As such, the communication device 32 generally comprises a modem, server, or other devices for communicating with other devices on the network 2.

As illustrated in FIG. 8, the online banking systems 30 comprise computer-readable program instructions 38 stored in the memory device 36, which in one embodiment includes the computer-readable instructions 38 of an online banking application 37. In some embodiments, the memory device 36 includes a datastore 39 for storing data related to the online banking systems 30, including but not limited to data created and/or used by the online banking application 37. The online banking application 37 allows the user 9, in one embodiment, to provide expense information manually or automatically, and receive account recommendations from the financial institution or third parties.

The other financial institution systems 40 are operatively coupled to the user computer systems 10, reward accounts systems 20, online banking systems 30, or third-party systems 50, through the network 2. The other financial institution systems 40 have devices the same as or similar to the devices described for the user computer systems 10 and reward account systems 20 (e.g., communication device, processing device, memory device with computer-readable instructions, datastore, or the like). Thus, the other financial institution systems 40 communicate with the user computer systems 10, reward accounts systems 20, online banking systems 30, or third-party systems 50 in the same or similar way as previously described with respect to the user computer systems 10, reward accounts systems 20, and/or the online banking systems 30. The other financial institution systems 40, in some embodiments, provide expense information (e.g., transaction information, account information, or the like) that may be used to determine recommended reward accounts.

The third-party systems 50 are operatively coupled to the user computer systems 10, reward accounts systems 20, online banking systems 30, or other financial institution systems 40 through the network 2. The third-party systems 50 have devices the same or similar to the devices described for the user computer systems 10, reward accounts systems 20, online banking systems 30, and/or other financial institution systems 40 (e.g., communication device, processing device, memory device with computer-readable instructions, datastore, or the like). Thus, the third-party systems 50 communicate with the user computer systems 10, reward accounts systems 20, online banking systems 30, and/or other financial institution systems 40 in the same or similar way as previously described with respect to each system. The third-party systems 50, in some embodiments, are comprised of systems of third-party financial institutions, financial service providers, software services, merchants, or the like that store and provide expense information or other information to the financial institution, user 9, or the like.

It is understood that the systems and devices described herein illustrate one embodiment of the invention. It is further understood that one or more of the systems, devices, or the like can be combined or separated in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing account recommendations based on rewards associated with accounts and expenses of a user, the system comprising:
a memory device; and
a processing device operatively coupled to the memory device, wherein the processing device is configured to execute computer-readable program code to:
identify user expenses for one or more categories from one or more current accounts of the user;
identify current rewards associated with the one or more current accounts for the one or more categories;
identify available rewards associated with one or more available accounts for the one or more categories;
determine one or more recommended accounts for the one or more categories to maximize the rewards for the user based on the current rewards associated with the one or more current accounts, the available rewards associated with the one or more available accounts, and the user expenses for the one or more categories; and
display the one or more recommended accounts to the user.

2. The system of claim 1, wherein the user expenses for the one or more categories are manually inputted by the user through an expense interface.

3. The system of claim 1, wherein the user expenses for the one or more categories are automatically provided by a financial institution that provides the one or more current accounts to the user and stores expense information related to the user expenses.

4. The system of claim 1, wherein the user expenses for the one or more categories are automatically provided by a third-party institution that stores expense information related to the user expenses for the one or more current accounts.

5. The system of claim 1, wherein the processing device is further configured to execute computer-readable program code to:
identify the one or more available accounts for which the user is eligible; and
wherein determining the one or more recommended accounts is further based on the one or more available accounts for which the user is eligible.

6. The system of claim 1, wherein the processing device is further configured to execute computer-readable program code to:
receive an indication from the user for the rewards in which the user is interested; and
wherein determining the one or more recommended accounts is further based on the rewards in which the user is interested.

7. The system of claim 1, wherein displaying the one or more recommended accounts to the user comprises displaying the one or more recommended accounts in an online banking application of the user.

8. The system of claim 1, wherein displaying the one or more recommended accounts to the user comprises displaying estimated rewards for the one or more recommended accounts based on the user expenses compared to the current rewards for the one or more current accounts based on the user expenses.

9. The system of claim 1, wherein displaying the one or more recommended accounts to the user comprises displaying estimated rewards for the one more categories for the one or more recommended accounts based on the user expenses compared to the current rewards for the one or more categories for the one or more current accounts based on the user expenses.

10. A computer program product for providing account recommendations based on rewards associated with accounts and expenses of a user, the computer program product comprising at least one non-transitory computer-readable medium having computer-readable program code portions embodied therein, the computer-readable program code portions comprising:
an executable portion configured to identify user expenses for one or more categories from one or more current accounts of the user;
an executable portion configured to identify current rewards associated with the one or more current accounts for the one or more categories;
an executable portion configured to identify available rewards associated with one or more available accounts for the one or more categories;
an executable portion configured to determine one or more recommended accounts for the one or more categories to maximize the rewards for the user based on the current rewards associated with the one or more current accounts, the available rewards associated with the one or more available accounts, and the user expenses for the one or more categories; and
an executable portion configured to display the one or more recommended accounts to the user.

11. The computer program product of claim 10, wherein the user expenses for the one or more categories are manually inputted by the user through an expense interface.

12. The computer program product of claim 10, wherein the user expenses for the one or more categories are automatically provided by a financial institution that provides the one or more current accounts to the user and stores expense information related to the user expenses.

13. The computer program product of claim 10, wherein the user expenses for the one or more categories are automatically provided by a third-party institution that stores expense information related to the user expenses for the one or more current accounts.

14. The computer program product of claim 10, wherein the computer-readable program code portions further comprise:
an executable portion configured to identify the one or more available accounts for which the user is eligible; and
wherein the executable portion configured to determine the one or more recommended accounts is further based on the one or more available accounts for which the user is eligible.

15. The computer program product of claim 10, wherein the computer-readable program code portions further comprise:
an executable portion configured to receive an indication from the user for the rewards in which the user is interested; and
wherein the executable portion configured to determine the one or more recommended accounts is further based on the rewards in which the user is interested.

16. The computer program product of claim 10, wherein the executable portion configured to display the one or more recommended accounts to the user comprises displaying the one or more recommended accounts in an online banking application of the user.

17. The computer program product of claim 10, wherein the executable portion configured to display the one or more recommended accounts to the user comprises displaying estimated rewards for the one or more recommended accounts based on the user expenses compared to the current rewards for the one or more current accounts based on the user expenses.

18. The computer program product of claim 10, wherein the executable portion configured to display the one or more recommended accounts to the user comprises displaying estimated rewards for the one more categories for the one or more recommended accounts based on the user expenses compared to the current rewards for the one or more categories for the one or more current accounts based on the user expenses.

19. A method for providing account recommendations based on rewards associated with accounts and expenses of a user, the method comprising:
identifying, by a processing device, user expenses for one or more categories from one or more current accounts of the user;
identifying, by the processing device, current rewards associated with the one or more current accounts for the one or more categories;
identifying, by the processing device, available rewards associated with one or more available accounts for the one or more categories;
determining, by the processing device, one or more recommended accounts for the one or more categories to maximize the rewards for the user based on the current rewards associated with the one or more current accounts, the available rewards associated with the one or more available accounts, and the user expenses for the one or more categories; and
displaying, by the processing device, the one or more recommended accounts to the user.

20. The method of claim 19, wherein the user expenses for the one or more categories are manually inputted by the user through an expense interface, automatically provided by a financial institution that provides the one or more current accounts to the user and stores expense information related to the user expenses, and automatically provided by a third-party institution that stores expense information related to the user expenses for the one or more current accounts.
